(19) United States
(12) Patent Application Publication
(10) Pub. No.: US 2017/0122009 A1
(43) Pub. Date: May 4, 2017

(54) Lock Having Locker Interiorly Formed Therein

(71) Applicant: REAL LOCKS & SECURITY Co., Ltd., NEW TAIPEI CITY (TW)

(72) Inventor: I-Hui Ho, New Taipei City (TW)

(73) Assignee: REAL LOCKS & SECURITY Co., Ltd.

(21) Appl. No.: 15/331,165

(22) Filed: Oct. 21, 2016

(30) Foreign Application Priority Data
Oct. 29, 2015 (TW) 104217292

(51) Int. Cl. E05B 67/02; E05B 63/14; E05B 35/08; E05B 67/22; E05B 67/38; E05B 65/00; E05B 67/00

(52) U.S. Cl. CPC E05B 67/02; E05B 65/0075; E05B 63/143; E05B 67/003; E05B 67/22; E05B 67/383; E05B 35/08

(57) ABSTRACT

A lock includes a lock body lockable on a fixed object or place, and a locker formed in the lock body, with the locker consisting of at least one locking chamber formed in the lock body for hiding, storing or locking a privacy or valuable thing in the locking chamber of the lock for security.

### RELATED APPLICATION

This application claims the benefit of a Taiwanese patent application, 104217292, filed on Oct. 29, 2015, the specification of which is incorporated here by this reference.

### BACKGROUND OF THE INVENTION

A privacy thing or valuable may always be locked in a drawer or safe. Such a privacy thing may include lover's pledge, token gift, or valuable diamond, which once locked in the safe or drawer, will not be easily moved or transported. When the privacy or valuable thing is required to be exchanged, it is especially inconvenient since the thing is locked in the heavy safe or a drawer secured in a table or cabinet.

It is therefore expected to invent a lock having a locker formed in itself for locking such privacy or valuable things in the locker in the lock.

### SUMMARY OF THE INVENTION

The object of the present invention is to provide a lock including a lock body lockable on a fixed object or place, and a locker formed in the lock body, with the locker consisting of at least one locking chamber formed in the lock body for hiding, storing or locking a privacy or valuable thing in the locking chamber of the lock for security.

### BRIEF DESCRIPTION OF THE DRAWINGS

FIG. 1 is an exploded view of a first preferred embodiment of the present invention.

FIG. 2 is a partially perspective view of the present invention when viewed from a bottom side of the embodiment of FIG. 1.

FIG. 3 is a bottom plan view of FIG. 2.

FIG. 4 is an illustration showing the assembled lock from FIG. 1.

FIG. 5 is a partially cut-away illustration of the present invention.

FIG. 6 is a sectional drawing as viewed from Line 6-6 of FIG. 4.

FIG. 7 is a sectional drawing as viewed from Line 7-7 of FIG. 4.

FIG. 8 shows an unlocked lock of the present invention for opening the cover.

FIG. 9 shows the lock of the present invention after removing the cover for taking or storing things from or in the lock.

FIG. 10 shows a second preferred embodiment of the present invention.

FIG. 11 shows a third preferred embodiment of the present invention.

FIG. 12 shows a fourth preferred embodiment of the present invention.

FIG. 13 shows a fifth preferred embodiment of the present invention as exploded.

FIG. 14 is a partial cut-away illustration of FIG. 13.

FIG. 15 shows a sectional drawing of FIG. 14.

FIG. 16 is an illustration for dismantling the elements of FIG. 15.

FIG. 17 shows a sixth preferred embodiment of the present invention.

FIG. 18 shows a seventh preferred embodiment of the present invention.

FIG. 19 is a partial sectional drawing of FIG. 18.

FIG. 20 shows an eighth preferred embodiment of the present invention.

### DETAILED DESCRIPTION

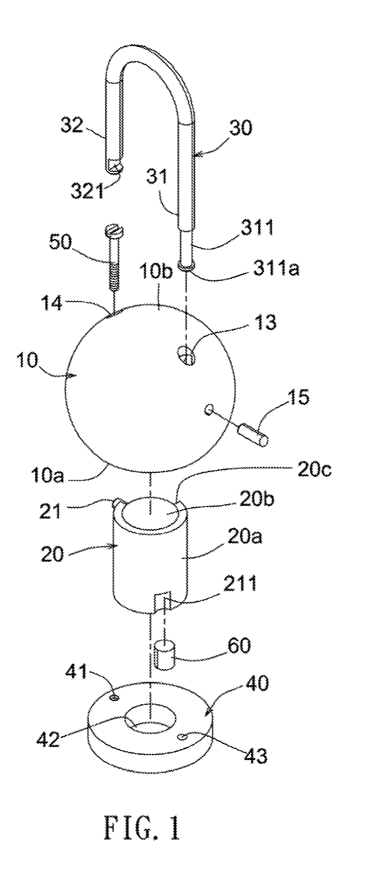

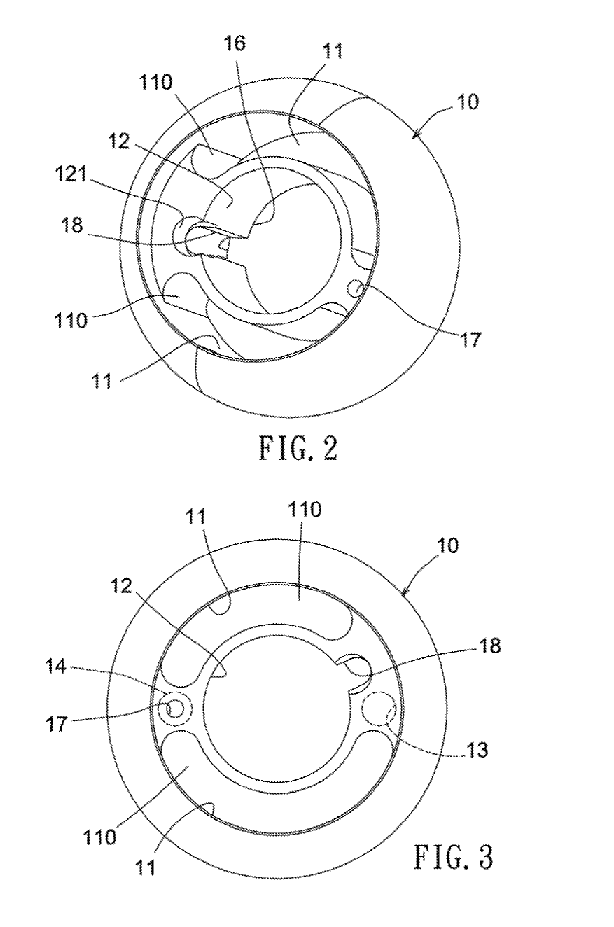

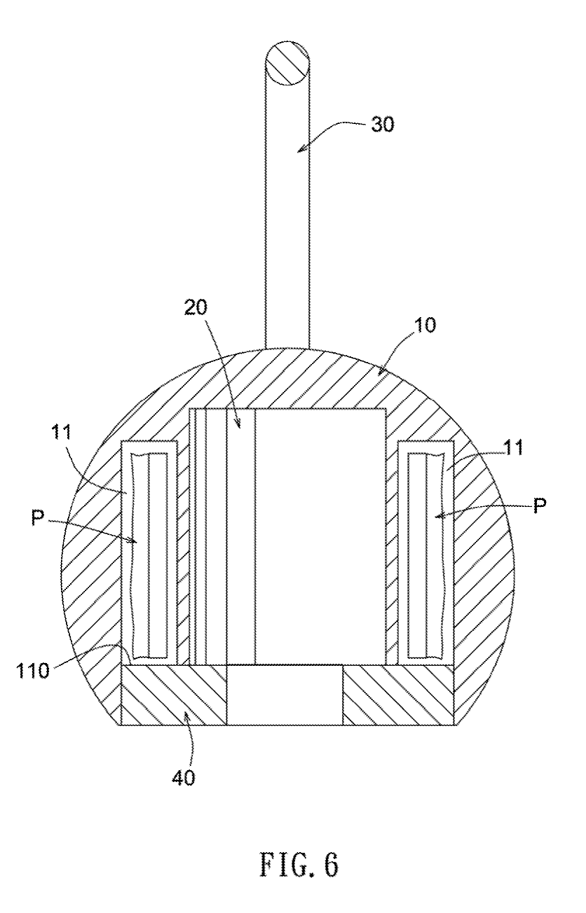

As shown in FIGS. 1, 2 and 6, the present invention, a lock having locker interiorly formed therein, comprises: a lock body 10, a lock core 20, a shackle 30 which may be a U-shaped shackle and is lockable on a fixed object or place, a cover 40, and a locking element 50. The lock body 10 includes a locker having at least a locking chamber 11 formed in the lock body 10. The locking chamber 11 is normally covered by a the cover 40, which is secured to the lock body 10 by the locking element 50, and is adapted for storing privacy matters, important or memorial letters or documents or any valuable things or small items P in the locking chamber 11 for security protection. The locking element 50 is normally concealed in the lock body 10 when locked by the shackle 30 to prevent from any unexpected intrusion trying to drive the locking element 50 in order to open the cover 40 to take away the valuable things as kept in the locking chamber 11.

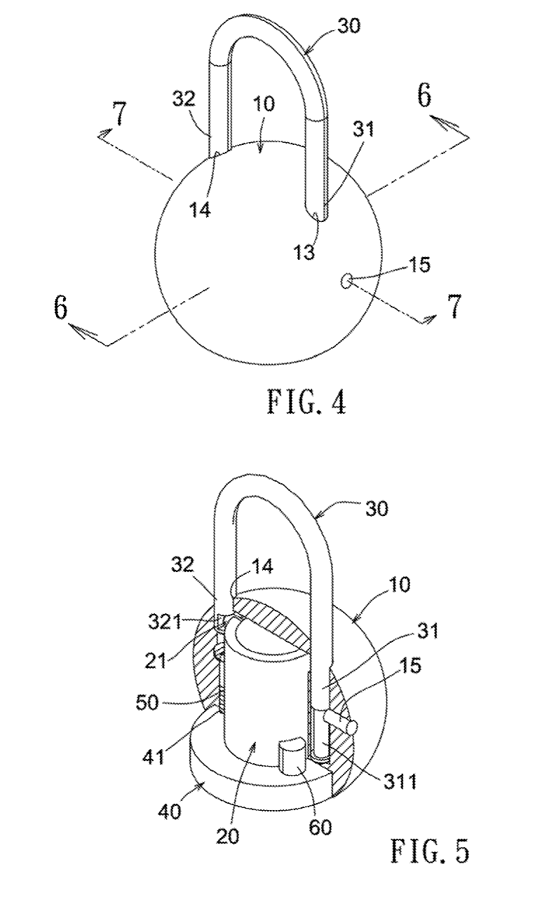

As shown in FIGS. 1-7, the lock of the present invention comprises: a lock body 10, a locker including a locking chamber 11 recessed in the lock body 10 and having an access port 110 communicated with the locking chamber 11 for inserting or storing the privacy or valuable things P into the locking chamber 11; a lock core 20 mounted in the lock body 10 and having a locking tongue 21 formed on the lock core 20 to be cooperatively actuated by the lock core 20 when locked or unlocked; a shackle 30 movably mounted on the lock body 10 and operatively locked by the locking tongue 21 when locked; a cover 40 adjacent to the access port 110 for covering the access port 110 of the locking chamber 11; and a locking element 50 movably secured in the lock body 10 for fixing the cover 40 on the lock body 10 for normally closing the locking chamber 11 for safely protecting the privacy things P as stored in the locking chamber 11, with said locking element 50 being concealed and locked within the lock body 10 by the shackle 30 when the lock of the present invention is locked to thereby prevent the locking element 50 from being dismantled or removed from the lock body for opening the cover 40. Upon unlocking of the present invention, a key (not shown) is inserted into the lock core 20 through a key hole 42 formed through the cover 40 for unlocking the lock core 20 for disengaging the shackle 30 from the locking tongue 21 to move the shackle 30 away from the lock body 10 in order to operate the locking element 50 to dismantle the cover 40, thereby taking the things P out from the locking chamber 11 or storing things P in the chamber 11.

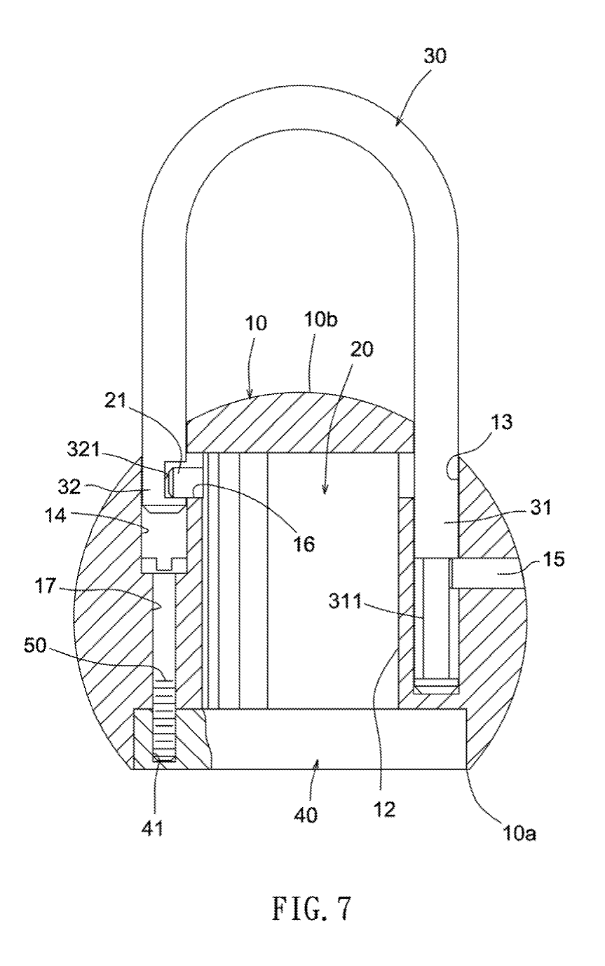

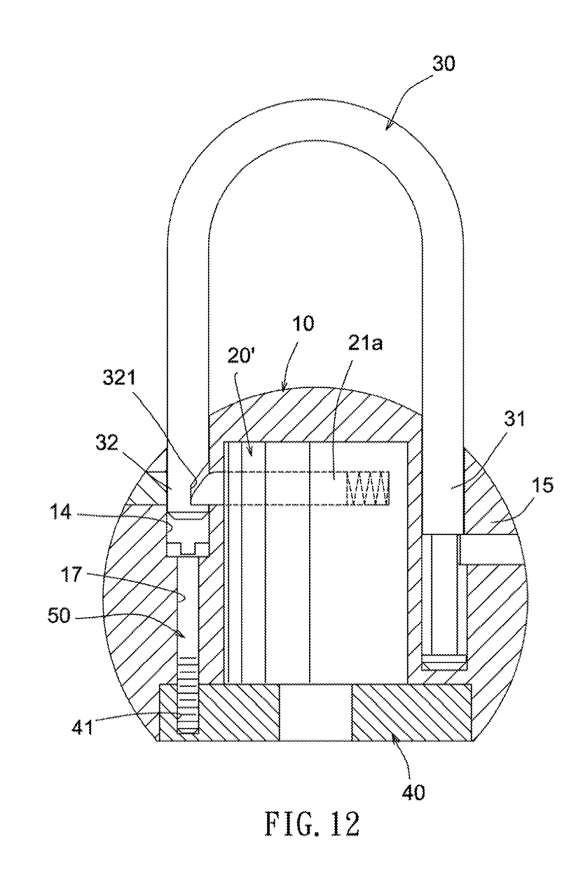

The lock core 20 includes a plug 20b rotatably mounted in an outer cylinder 20a secured in the lock body 10; a locking tongue 21 formed on the plug 20a; a locking mechanism (not shown, and generally including a pin tumbler, a latch or any other locking elements) formed between the outer cylinder 20a and the plug 20b, normally being locked for retarding the rotation of the plug 20b within the outer cylinder 20a, and operatively unlocked when inserting a key into the plug 20b for rotating the plug 20b within the outer cylinder 20a for disengaging the locking tongue 21 from the shackler 30 for opening the lock of the present invention. The locking tongue 21 is formed on an upper portion of the plug 20b and is movably sliding in a notch 20c (FIG. 1) cut in an upper portion (or sliding on an upper portion) of the outer cylinder 20a and a guiding slot 16 (FIG. 7) formed in the lock body 10 for locking the shackle 30. In FIG. 12, the locking tongue 21a is, however, resiliently mounted in the lock core 20 to be a modification of the locking tongue 21, not limited in the present invention.

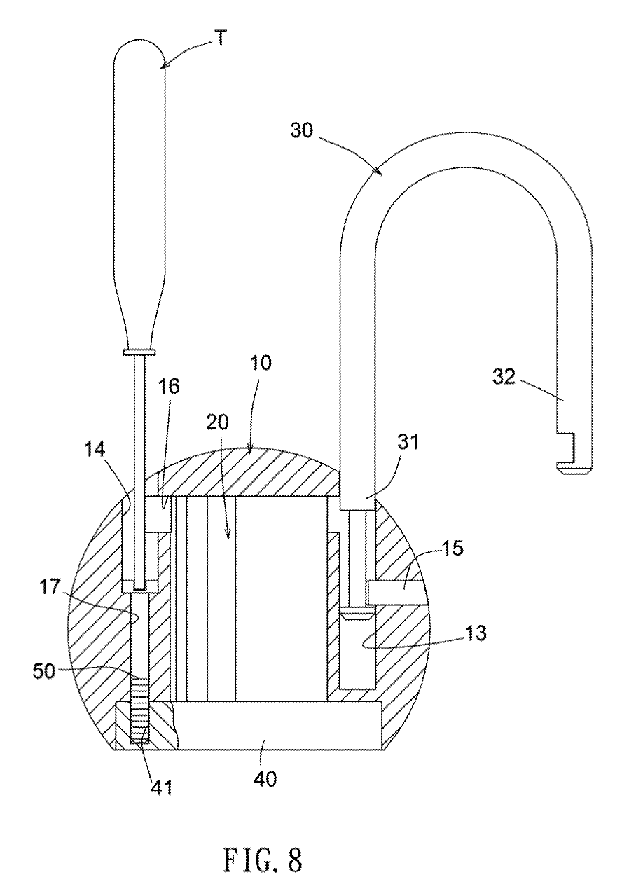

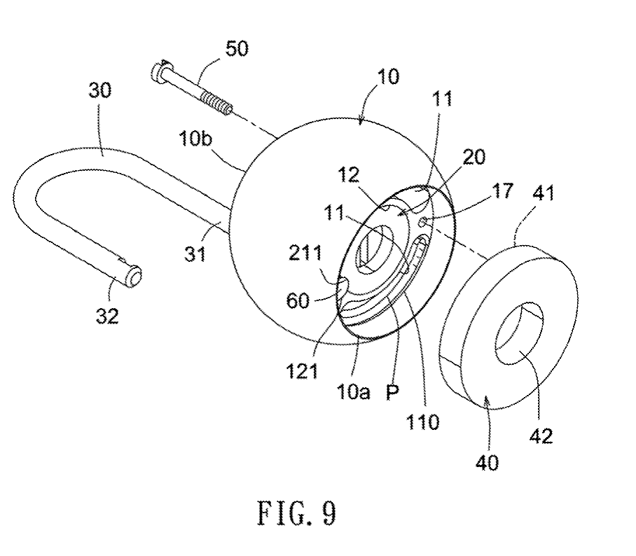

As shown in FIGS. 8 and 9, when the lock core 20 is unlocked, the locking tongue 21 is no longer engaged with the shackle 30 so that the shackle 30 can be removed (pulled upwardly and then rotated about the first leg 31 (in first leg hole 13) to reveal the locking element 50 as fixed in the screw hole 17. Then a tool T may be inserted into the second leg hole 14 to unscrew or unlock the locking element 50 in order to unfasten the cover 40. Upon opening of the cover 40, the things P may then be taken out or away from the locking chamber 11. Or, the things P including privacy letter, pledge matter or valuable items may be stored into the locking chamber 11. The cover 40 will then be re-closed onto the lock body 10.

As shown in FIGS. 1-9, the lock body 10 is recessed or formed with a locking chamber 11 and a core cavity 12 in a first end portion 10a of the lock body 10 for mounting the lock core 20 in the core cavity 12. In a second end portion 10b of the lock body 10, a first leg hole 13 and a second leg hole 14 are respectively formed in the second end portion 10b, adapted for inserting a first leg 31 of the U-shaped shackle 30 into the first leg hole 13 and for inserting the second leg 32 of the shackle 30 into the second leg hole 14. The second leg hole 14 is communicated with the core cavity 12 so as to protrude the locking tongue 21 into the second leg hole 14 in order to engage with a locking groove 321 recessed in the second leg 32 for locking the second leg 32 in the second leg hole 14 of the lock body 10 as shown in FIGS. 7 and 5. The first leg 31 includes a narrow neck portion 311 having a diameter of the narrow neck portion 311 smaller than a diameter of the first leg 31 and a retainer 311a formed on a bottom end of the first leg 31, whereby a limiting pin 15 is inserted laterally, through a pin hole formed through a side portion of the lock body 10, into the first leg hole 13 to be engaged with the narrow neck portion 311 of the first leg 31 of the shackle 30 for rotatably limiting the first leg 31 in the first leg hole 13 without being withdrawn or removed outwardly from the first leg hole 13 of the lock body 10 as shown in FIGS. 7 and 8.

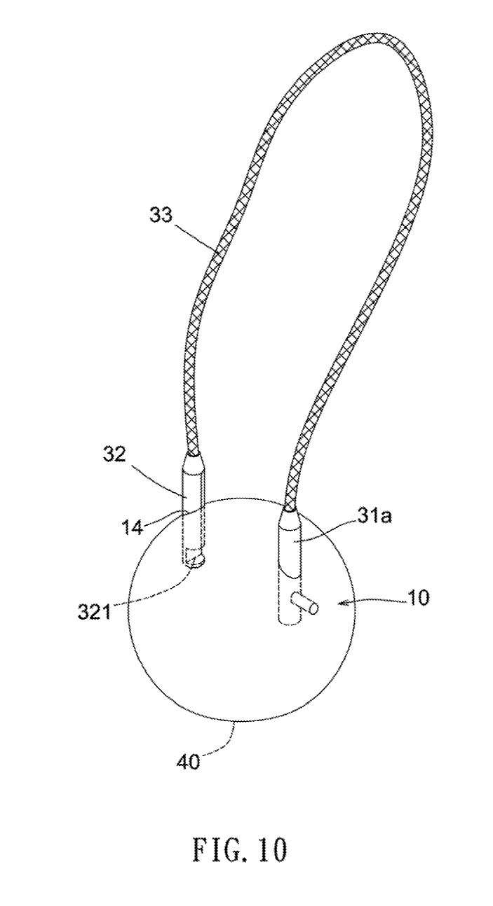

As shown in FIG. 10, the shackle 30 includes a first leg 31a as modified from the first leg 31 as shown in FIG. 1 and connected in the lock body 10, a second leg 32 opposite to the first leg 31a and inserted into the second leg hole 14, having a locking groove 321 formed in the second leg 32 to be locked by the locking tongue 21, and a flexible member 33 selected from a wire, a rope, a chain or a band connected between the two legs 31a, 32.

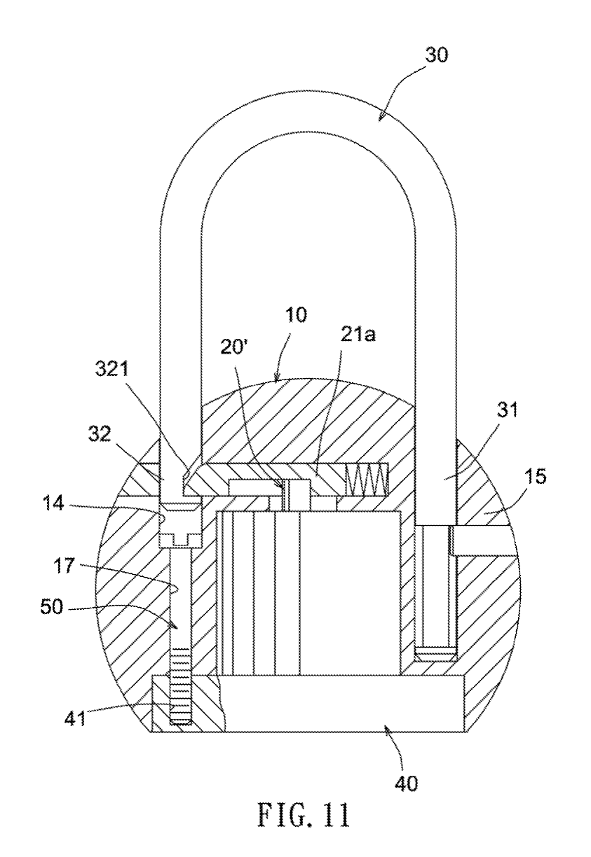

As shown in FIG. 11, the locking tongue 21a of the lock core 20 is resiliently held in the lock body 10 adjacent to a top of the core cavity 12 and normally protruding outwardly, through a guiding slot 16 formed in the lock body 10, into the second leg hole 14 to be engaged with the locking groove 321 of the shackle 30 for locking the lock of the present invention; and the locking tongue 21a is operatively retracted inwardly in the lock body 10 for pulling the shackle 30 upwardly when unlocking the lock of the present invention.

The lock body 10 includes a screw (or bolt) hole 17 longitudinally formed through the lock body 10 just beneath the second leg hole 14 to thereby communicate the second leg hole 14. The screw hole 17 is adapted to be fixed with a locking element (or screw) 50, which is fixed in the screw hole 17 to be engaged with a cover screw hole 41 formed in an inner surface portion of the cover 40 so that the cover 40 will be secured to the lock body 10 to close the locking chamber 11 as formed in the lock body 10 for safely locking the privacy things P in the locking chamber 11. When the present invention is locked, the locking element 50 is concealed in the lock body 10 as locked by the second leg 32 and the cover 40 as shown in FIGS. 7, 11, 12, etc. Such a locking element or screw 50 can not be dismantled from outside of the lock since the locking element 50 as been safely locked in the second leg hole 14 as aforementioned, thereby enforcing the security of the present invention.

As shown in FIGS. 1, 5 and 9, a core-limiting pin 60 is provided in between the lock body 10 and the lock core 20 to prevent from a self-rotation of the outer cylinder 20a of the lock core 20 within the core cavity 12 in the lock body 10. For instance, the core-limiting pin 60 is engaged in a body recess 121 of the lock body 10 and a core recess 211 of the lock core 20, especially as shown in FIGS. 9 and 5.

In practical applications, the present invention includes a padlock, a combination lock, a locking chain or any decorative pendent articles (locks), not limited in the present invention. When inserting a key (not shown) through a key hole 42 formed through the cover 40 to unlock the lock core 20, the locking tongue 21 will be retracted to be disengaged from the locking groove 321 of the shackle 30 to thereby allow the shackle 30 be pulled outwardly or upwardly and then rotated about the first leg 31 in order to remove the second leg 32 from the second leg hole 14, thereby revealing the locking element 50 as fixed in the screw hole 17. By the way, a tool T such as a driver (FIGS. 8, 9) may be applied to unlock the locking element 50 from the hole 17 and dismantle the cover 40 from the lock body 10 so as to take the things P out from the locking chamber 11 or to store or hide the things P into the locking chamber 11. Such things P including letter, pledge, token, diamond or other privacy items may be stored safely in the locking chamber 11.

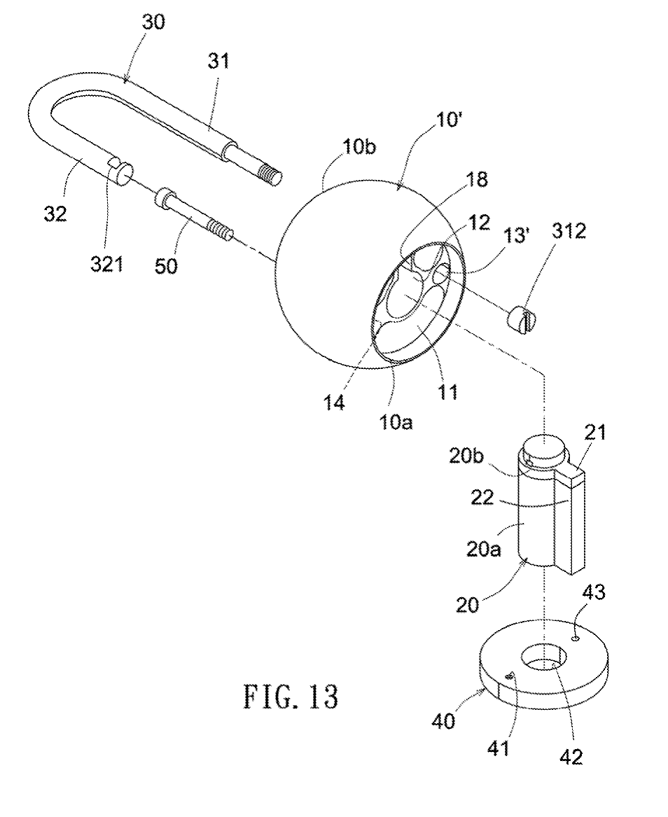

As shown in FIGS. 13˜16, the lock of the present invention comprises: a lock body 10′, a lock core 12 formed or recessed in a first end 10a of the lock body 10′, a first leg hole 13′ longitudinally formed in a first side of the lock body 10′ having a shoulder portion 131 annularly formed in the first leg hole 13′, a second leg hole 14 longitudinally formed in a second side of the lock body 10′ opposite to the first leg hole 13′, a guiding slot 16 arcuately radially recessed in an upper portion of the core cavity 12 to be communicated with the second leg hole 14, a screw hole 17 longitudinally recessed in the second leg hole 14 through the lock body 10′, a shackle 30 having a first leg 31 inserted into the first leg hole 13′ and a second leg 32 inserted into the second leg hole 14, a lock core 20 having an outer cylinder 20a fixed in the core cavity 12 and a plug 20b rotatably mounted in the outer cylinder 20a, a locking tongue 21 formed on an upper portion of the plug 20b and slidably rotatably engaged in the guiding slot 16 to be locked with a locking groove 321 recessed in the second leg 32 for locking the shackle 30 into the lock body 10′, a cover 40 having a key hole 42 formed through a central portion of the cover 40 for inserting a key through the key hole 42 for unlocking the lock core 20 and having a screw hole 41 formed in an inside surface portion of the cover 40 to be engaged with a locking element (or screw) 50 fixed in the screw hole 17 to allow the cover 40 to close the lock core 20 and the locking chamber 11 as recessed in the first end 10a of the lock body 10.

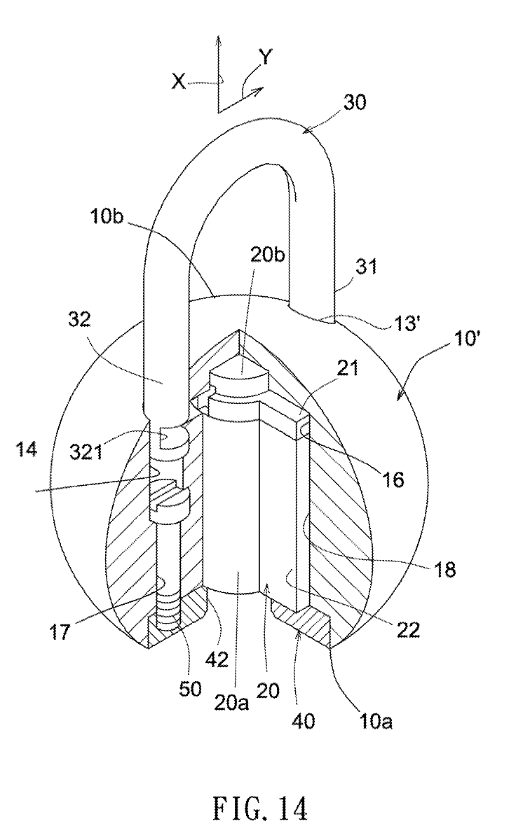

The definition of “longitudinal” or “longitudinally” as above-mentioned means a direction being parallel to the X-axis as shown in FIG. 14; while the “radial” or “radially” indicates a radial direction perpendicular to the X-axis such as Y-axis as shown in FIG. 14.

The shoulder portion 131 formed in the first leg hole 13′ may limit a bottom end of the first leg 31, having a retainer 312 fixed on a bottom end of the first leg 31 to prevent from a withdrawal or removal of the first leg 31 and the shackle 30 from the lock body 10′.

When the locking tongue 21 is rotatably slidably moved along the guiding slot 16 to be engaged with the locking groove 321 of the second leg 32, a stopper (not shown) may be formed in the guiding slot 16 in order to precisely engage the locking tongue 21 with the groove 321 of the second leg 32.

As shown in the drawings, the retainer 312 may be a C-shaped retainer. However, the retainer is not limited in the present invention and may be formed as a nut, a ring or a protrusion on a bottom end of the first leg 31.

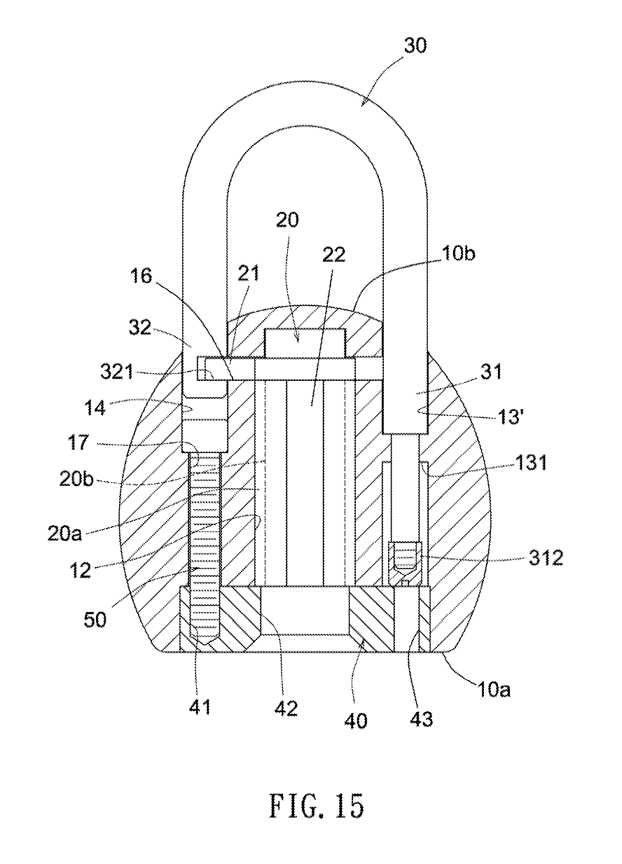

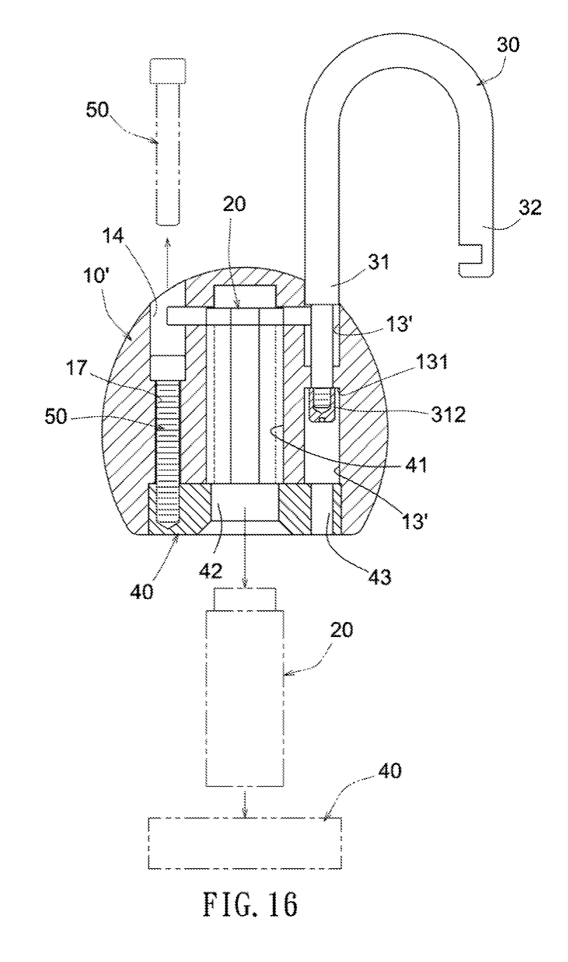

As shown in FIGS. 13 and 14, a longitudinal groove 18 is formed in the lock body 10 as radially recessed in the core cavity 12 and is upwardly communicated with the guiding slot 16 formed in an upper portion of the lock body 10. During the assembly of the present invention, the lock core 20 may be presented in a configuration as that as shown in FIG. 13, namely, the locking tongue 21 formed on the plug 20b is rotated or oriented to be aligned with a limiting protrusion 22 longitudinally formed on the outer cylinder 20a and the assembled lock core 20 is inserted into the core cavity 12 and the longitudinal groove 18 from the first end 10a of the lock body 10. More essentially speaking, the outer cylindrical surface of the lock core 20 is engaged with the core cavity 12, while the tongue 21 and the protrusion 22 as aligned are engaged with the groove 18, thereby implementing the whole lock core 20 snugly into the lock body 10. Upon rotation of the plug 20b, the locking tongue 21 will be engaged with the locking groove 321 of the second leg 32 of the shackle 30 as shown in FIG. 15 for locking the lock.

The limiting protrusion 22 as formed with the outer cylinder 20a of the lock core 20, once being engaged with the longitudinal groove 18 in the lock body 10, will prevent the lock core 20 from its free rotation within the core cavity 12.

As shown in FIGS. 13˜16, a retainer 312 is formed on a bottom end of the first leg 31 to limit the removal of the leg 31 and shackle 30 since the retainer 312 will be upwardly retarded against the shoulder portion 131 formed in the first leg hole 13′. Such a retainer 312 may be a nut or stopper having female threads formed therein to be engaged with the male threads formed on the bottom end of the first leg 31. By the way, the production or processing steps and cost may be reduced in comparison with the embodiment as aforementioned. For example, the retainer 311 a as integrally formed on the neck portion 311 of first leg 31 as shown in FIG. 1 should require a limiting pin 15, inserted through the lock body 10, to retard the retainer 311a to prevent withdrawal of the shackle 30 from the lock body 10, thereby increasing a production complexity and cost. So, the embodiment as shown in FIGS. 13˜16 will simplify the production of the lock since the retainer 312 is assembled onto the leg 31 of the shackle 30 without drilling the pin hole for pin 15, thereby saving mechanical processing and finishing treatment including surface grinding, polishing or electroplating for saving cost.

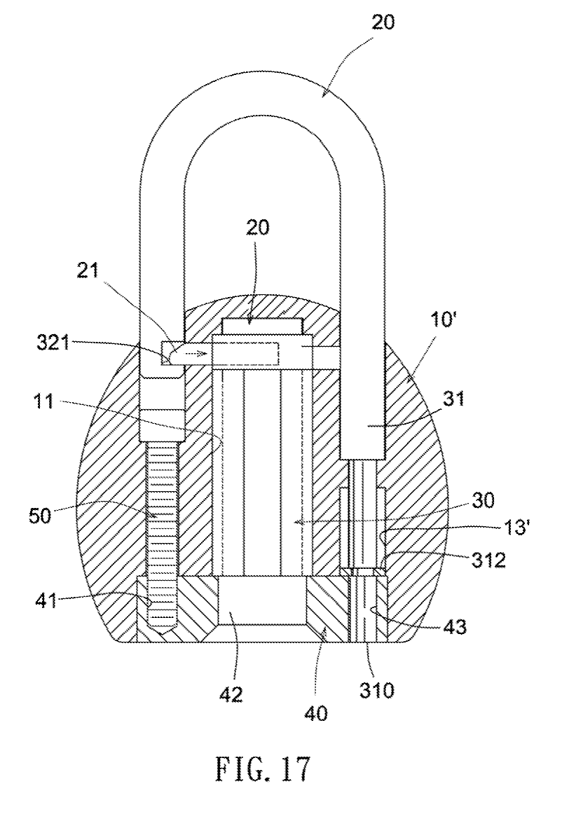

As shown in FIG. 17, the cover 40 is formed with a checking hole 43 through the cover 40 to be projectively aligned with the first leg hole 13′, while the checking hole 43 is diametrically aligned with the cover screw hole 41 as formed in the upper or inner surface of the cover 40 (FIG. 13) adapted for fixing the locking element or screw 50 in the cover screw hole 41. When aligning the checking hole 43 with the first leg hole 13′, it means that the cover screw hole 41 is axially aligned with the locking element 50 and the screw hole 17 formed in the lock body 10. This may help a precise and quick assembly of the locking element 50 into the hole 41 of the cover 40 for quickly precisely mounting the cover 40 onto the lock body 10. Besides, the checking hole 43 as formed in the cover 40 may be aligned with a sensing hole (not shown) formed in the lock body 10 at a suitable location. However, such a checking hole 43 or sensing hole should each be pre-determined for a specific angle as separated from the cover screw hole 41 or the screw hole 17.

As shown in FIG. 17, when the lock of the present invention is locked, a bottom end 310 of the first leg 31 is protruded into the checking hole 43 and may be coplanar to a bottom level of the check hole 43. In addition, the checking hole 43 provides a drainage to the lock.

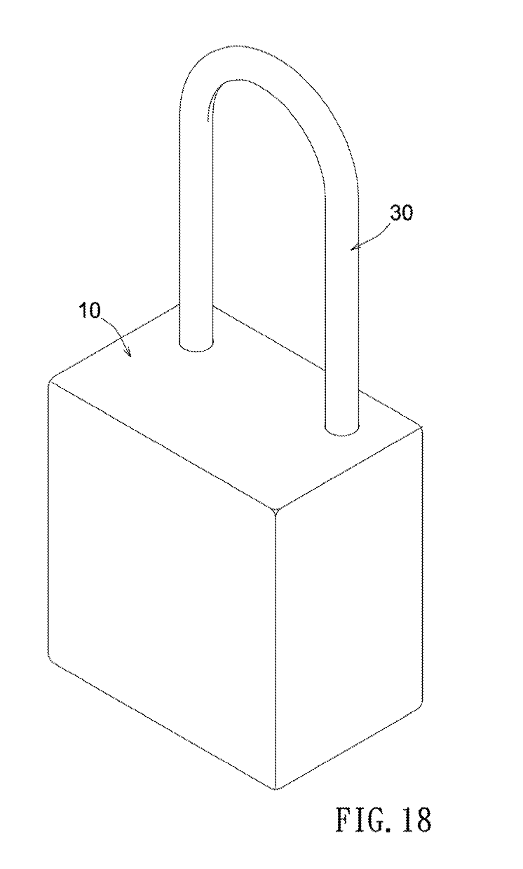

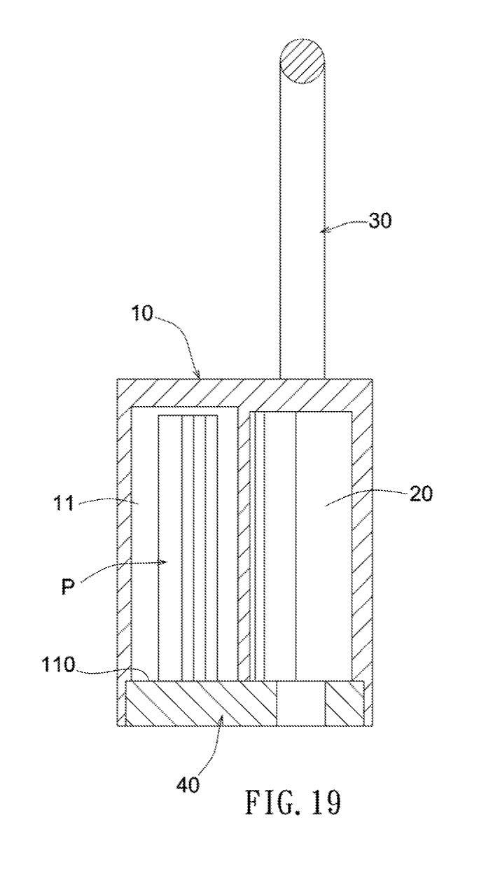

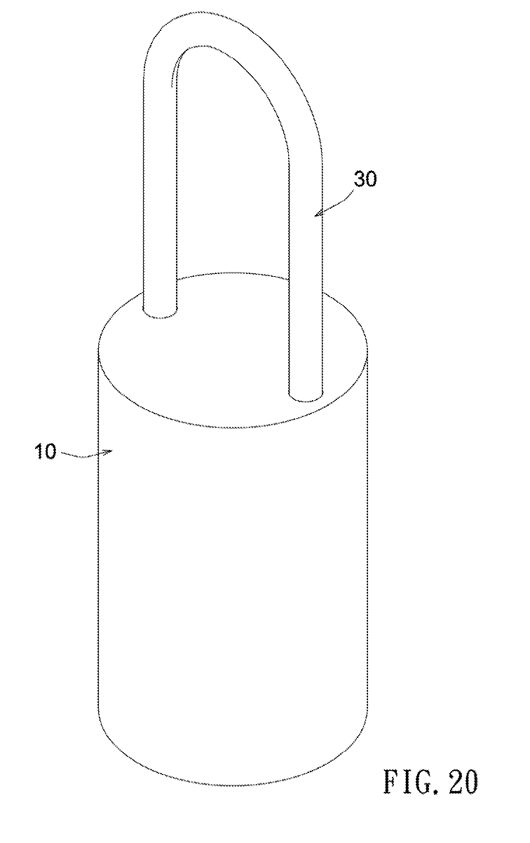

The lock body 10 may be formed as spherical shape, or parallelepiped shape as shown in FIGS. 18 and 19, or cylindrical shape as shown in FIG. 20, or any other shapes.

The present invention provides a lock for locking purpose as usual, and also provides at least a locking chamber 11 for hiding, storing or locking things P therein, including letter, pledge, token, privacy or personal information, lover's exchange items, time capsule, or valuables including diamond. Once locked at a proper location, the lock with its inner stored things will not be easily lost. Meanwhile, the lock of the present invention may be easily carried, portable or moved for convenient uses. Therefore, the lock of the present invention plays plural roles, especially the novel “locker-in-lock”, to increase its commercial value, novelty, creativity and uses.

The present invention may be further modified without departing from the spirit and scope of the present invention.

I claim:

1. A lock comprising:
a lock body;
a lock core mounted in a core cavity in said lock body;
at least a locking chamber formed in said lock body adapted for storing things including privacy things or valuables in said locking chamber;
a cover for closing an access port of said locking chamber;
a shackle lockable on a fixed object or place and having a first leg movably inserted in a first leg hole formed in said lock body and having a second leg inserted in a second leg hole formed in said lock body; and
a locking element inserted through said second leg hole to be fixed in said lock body having a bottom end portion of said second leg fixed to an inside surface portion of said cover for fixing said cover to said lock body, said locking element being concealed in said second leg hole and locked by said shackle when said lock core is locked for safely hiding or storing said things in said locking chamber; and upon unlocking of said lock core, said shackle and the second leg thereof are removed to reveal the locking element, whereby the locking element is unlocked to open the cover for taking things out from the locking chamber or for storing things into said locking chamber.

2. The lock according to claim 1, wherein said shackle is U-shaped and includes said first leg rotatably secured in said first leg hole formed in said lock body, having a narrow neck portion formed on said first leg to be rotatably limited by a limiting pin transversely fixed in said lock body, and said second leg insertable in said second leg hole formed in said lock body opposite to said first leg hole, having a locking groove formed in said second leg to be engaged with a locking tongue of said lock core.

3. The lock according to claim 1, wherein said shackle includes said first leg connected to said lock body; a second leg inserted in said second leg hole formed in said lock body and having a locking groove formed in said second leg to be locked by a locking tongue of said lock core; and a flexible member including a wire, a rope, a chain and a band, and connected between said first leg and said second leg.

4. The lock according to claim 1, wherein said lock body includes a guiding slot formed in said lock body and transversely communicated with said core cavity and said second leg hole of said shackle, allowing a locking tongue of said lock core sliding or protruding in said guiding slot, whereby said locking tongue is engaged with a locking groove formed in said second leg of said shackle for locking said shackle with said lock body.

5. The lock according to claim 1, wherein said cover is formed with a screw hole in an inside surface portion of said cover; and said locking element is a locking screw fixed through said second leg hole and through said lock body to be engaged with said screw hole in said cover for locking said cover onto said lock body.

6. The lock according to claim 5, wherein said cover includes a checking hole formed through said cover, said checking hole projectively aligned with a first leg hole of said lock body; said screw hole being diametrically aligned with said checking hole and said screw hole being axially aligned with said second leg hole in said lock body.

7. The lock according to claim 6, wherein said first leg of said shackle includes a bottom end portion of said first leg protruding downwardly into said checking hole in said cover.

8. The lock according to claim 7, wherein said bottom end portion of said first leg is coplanar to a bottom level of said checking hole of said cover when the shackle is locked.

9. The lock according to claim 1, wherein said lock core includes a core limiting pin inserted in between said core cavity and said lock core for preventing from a free rotation of said lock core in said lock body.

10. The lock according to claim 1, wherein said lock body is formed as a shape, including: a spherical shape, a parallelepiped shape, and a cylindrical shape.

11. The lock according to claim 1, wherein said first leg hole is formed with a shoulder portion in said first leg hole, said first leg having a retainer secured or formed on a bottom end of said first leg to prevent from an upward withdrawal of said first leg from the first leg hole as limited by said shoulder portion; said cover secured to said lock body by fixing a locking element into a screw hole formed in said cover; and said locking screw fixed in said lock body through said second leg hole formed in said lock body.

12. The lock according to claim 11, wherein said retainer includes: a nut, a C-shaped retainer, and a protrusion formed on a bottom end of said first leg.

13. A lock according to claim 11, wherein said cover includes a checking hole formed therethrough, said checking hole projectively aligned with said first leg hole and diametrically aligned with said screw hole in said cover, said screw hole being axially aligned with said first leg hole of said first leg in said lock body when said cover is fixed onto the lock body.

14. The lock according to claim 11, wherein said lock body includes a guiding slot formed in said lock body adjacent to an end portion of said core cavity, said guiding slot communicated with said second leg hole of said lock body.

15. The lock according to claim 1, wherein said lock core includes an outer cylinder fixed in said core cavity, a plug rotatably mounted in said outer cylinder, a locking tongue formed on said plug and radially protruding outwardly through an upper notch or an upper portion of said outer cylinder and through a guiding slot arcuately formed in said core cavity in said lock body to be engaged with a locking groove formed in said second leg of said shackle for locking said shackle with said lock body.

16. The lock according to claim 13, wherein said first leg of said shackle includes a bottom end portion of said first leg protruding downwardly into said checking hole of said cover.

17. The lock according to claim 16, wherein said bottom end portion of said first leg is coplanar to a bottom level of said checking hole when said shackle is locked in said lock body.
